(19) United States
(12) Patent Application Publication
(10) Pub. No.: US 2025/0337303 A1
(43) Pub. Date: Oct. 30, 2025

(54) METHOD OF ASSEMBLING A LAMINATED STEEL STACK FOR CASTING A ROTOR ASSEMBLY

(71) Applicant: GM GLOBAL TECHNOLOGY OPERATIONS LLC, Detroit, MI (US)

(72) Inventors: Qigui Wang, Rochester Hills, MI (US); Yi Liu, Troy, MI (US); Liang Wang, Rochester Hills, MI (US); Steven L. Burkholder, Archbold, OH (US); Jason J. Coryell, Rochester Hills, MI (US); Tyson W. Brown, Royal Oak, MI (US); Devin R. Hess, Clarkston, MI (US)

(73) Assignee: GM GLOBAL TECHNOLOGY OPERATIONS LLC, Detroit, MI (US)

(21) Appl. No.: 18/648,881

(22) Filed: Apr. 29, 2024

(51) Int. Cl. H02K 15/02; B22D 19/00; B32B 3/26; B32B 15/01; H02K 1/22

(52) U.S. Cl. CPC H02K 15/02; B22D 19/0054; B32B 3/266; B32B 15/011; H02K 1/22; B32B 2603/00

(57) ABSTRACT

A method of making a rotor assembly includes positioning a thin-film composite with a transfer member into engagement with a slot surface of a corresponding slot of a multitude of slots. The slots are formed around a perimeter of a laminated steel stack with each of the slots in the laminated steel stack being defined by a slot surface. The method also includes placing the laminated steel stack in a casting mold, having cavities for defining a pair of end rings on opposite ends of the laminated steel stack that are in fluid communication with the slots.

### INTRODUCTION

The present disclosure relates to a method of forming a rotor assembly and, more particularly, to coating slots in a laminated steel stack with a thin-film composite.

Rotor assemblies made of aluminum can be used in various applications due to their light weight, high conductivity, and good thermal dissipation properties. These assemblies typically consist of a rotor core, which is often made of stacked steel laminations and an aluminum alloy cage structure comprising conductive bars and end rings. The cage structure enables the induction of currents and the creation of a magnetic field that interacts with the stator's field to generate torque.

### SUMMARY

Disclosed herein is a method of making a rotor assembly. The method includes positioning a thin-film composite with a transfer member into engagement with a slot surface of a corresponding slot of a multitude of slots. The slots are formed around a perimeter of a laminated steel stack with each of the slots in the laminated steel stack being defined by a slot surface. The method also includes placing the laminated steel stack in a casting mold, having cavities for defining a pair of end rings on opposite ends of the laminated steel stack that are in fluid communication with the slots.

providing a laminated steel stack having slots formed around a perimeter of the laminated steel stack with each of the slots defined by a slot surface. A thin-film composite is positioned with a transfer member into engagement with the slot surface of a corresponding one of the slots. The laminated steel stack is placed within a casting mold. The casting mold includes cavities for defining a pair of end rings on opposite ends of the laminated steel stack that are in fluid communication with the slots.

In another aspect of the disclosure the thin-film composite includes an ultra-conducting composite having carbon nanotubes with a thickness of less than or equal to 25 microns.

In another aspect of the disclosure a portion of the thin-film composite engages a first axial end of the laminated steel stack and a second axial end of the laminated steel stack.

In another aspect of the disclosure a portion of the thin-film composite engages a radially outer surface defining an outer circumference of the laminated steel stack.

In another aspect of the disclosure the thin-film composite includes a predetermined length having a first end located on a first circumferential side of one of the slots and a second end of the thin-film composite on a second circumferential side the corresponding one of the slots.

In another aspect of the disclosure positioning the thin-film composite with the transfer member includes rolling a predetermined length of the thin-film composite around on the transfer member including a transfer roller and positioning the predetermined length of the thin-film composite in contact with the slot surface of a corresponding one of the slots while unrolling the thin-film composite from the transfer member.

In another aspect of the disclosure rolling the predetermined length of the thin-film composite around the transfer member includes cutting the thin-film composite with a laser at the predetermined length.

In another aspect of the disclosure positioning the thin-film composite with the transfer member includes fixing a first end of the thin-film composite relative to the laminated steel stack, positioning the thin-film composite in contact with the slot surface of a corresponding one of the slots while unrolling the thin-film composite from the transfer member, and cutting the thin-film composite to a predetermined length.

In another aspect of the disclosure positioning the thin-film composite includes securing the thin-film composite to an outer surface of the transfer member including a slot insert and placing the transfer member with the thin-film composite within one of the slots in the laminated steel stack. Positioning also includes transferring the thin-film composite from the transfer member to the slot surface or a corresponding one of the slots and removing the transfer member from the laminated steel stack.

In another aspect of the disclosure the transfer member includes a body portion that defines an internal cavity on an inner side and the outer surface on an outer side with passages defined by the body portion and fluidly connecting the internal cavity with the outer surface.

In another aspect of the disclosure securing the thin-film composite to the outer surface of the transfer member includes applying a vacuum to the internal cavity of the transfer member.

In another aspect of the disclosure transferring the thin-film composite to the slot surface includes applying a positive pressure source to the internal cavity of the transfer member.

In another aspect of the disclosure the transfer member is magnetic.

Disclosed herein is a method of assembling a laminated steel stack for a rotor assembly. The method includes locating a thin-film composite in contact with a transfer member and positioning the thin-film composite with the transfer member into engagement with a slot surface of a corresponding one of a multitude of slots formed around a perimeter of the laminated steel stack. Each of the plurality of slots in the laminated steel stack are defined by a slot surface.

In another aspect of the disclosure positioning the thin-film composite with the transfer member includes rolling a predetermined length of the thin-film composite around a transfer roller and positioning the predetermined length of the thin-film composite in contact with the slot surface of a corresponding one of the slots while unrolling the thin-film composite from the transfer member.

Disclosed herein is a rotor assembly. The rotor assembly includes a laminated steel stack having steel sheets with an outer surface of the laminated steel stack including a slots extending continuously from a first axial end of the laminated steel stack to a second axial end of the laminated steel stack. The assembly also includes a thin-film composite in engagement with a slot surface of each of the slots in the laminated steel stack and a rotor cage. The rotor cage includes cast conductor bars located in a corresponding one of the slots in the laminated steel stack and in contact with the thin-film composite. The rotor cage also includes a first end ring located at a first axial end of the rotor cage and a second end ring located at a second axial end of the rotor cage, with the first end ring, the second end ring, and the cast conductive bars comprised of cast aluminum.

### BRIEF DESCRIPTION OF THE DRAWINGS

FIG. 1 schematically illustrates an example rotor assembly according to this disclosure.

FIG. 2 schematically illustrates an example laminated steel stack from the rotor assembly of FIG. 1.

FIG. 3 schematically illustrates an example method for applying a thin-film composite to the laminated steel stack of FIG. 2 with an example transfer roller.

FIG. 4 schematically illustrates another example method for applying a thin-film composite to the laminated steel stack of FIG. 2 with another example transfer roller.

FIG. 5 schematically illustrates another example method of applying a thin-film composite to the laminated steel stack of FIG. 2 with an example transfer member.

FIG. 6 schematically illustrates yet another example method of applying a thin-film composite to the laminated steel stack of FIG. 2 with another example transfer member.

FIG. 7 illustrates a method of casting the rotor assembly of FIG. 1 with the laminated steel stack having the thin-film composite.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

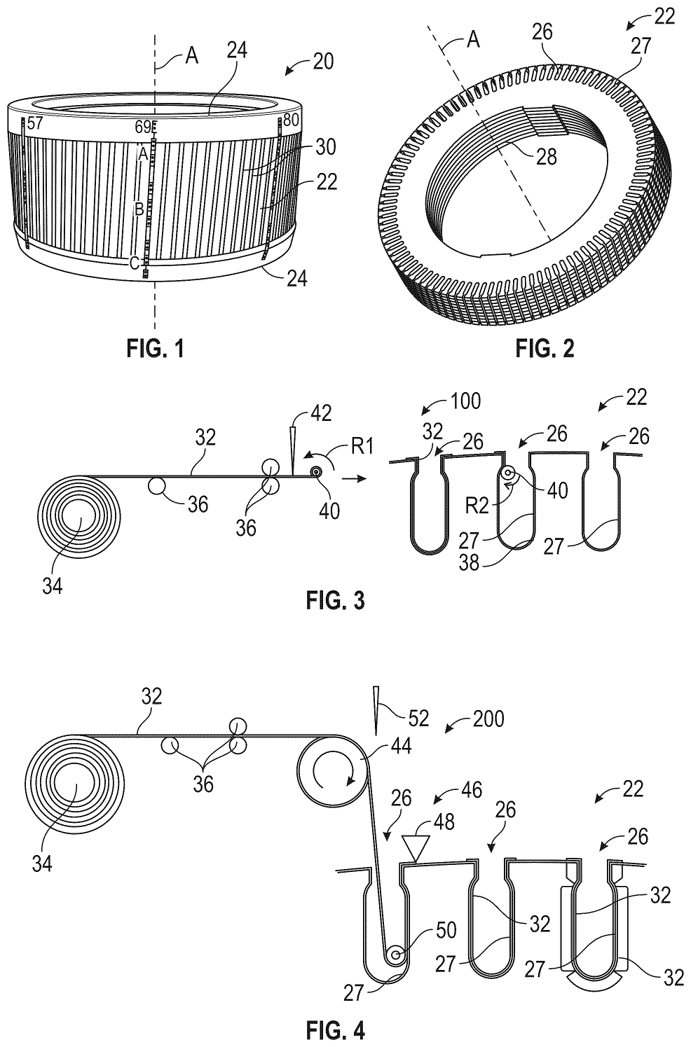

FIG. 1 illustrates an example rotor assembly 20. The rotor assembly 20 may be used in an electric machine, such as an induction motor, in connection with a stator. The electric machine may be used in a motor vehicle including, but not be limited to, a commercial vehicle, industrial vehicle, passenger vehicle, aircraft, watercraft, train or the like. It is also contemplated that the motor vehicle may be a mobile platform, such as an airplane, all-terrain vehicle (ATV), boat, personal movement apparatus, robot and the like. In the illustrated example, the rotor assembly 20 includes a laminated steel stack 22 that forms a core and is at least partially surrounded by a cage. The cage may be formed of a cast material, such as aluminum. The cage can include end rings 24 located at axial ends of the rotor assembly 20 and cast conductive bars 30 extending axially between the end rings 24 and through slots 26 (FIG. 2) in the laminated steel stack 22.

As shown in FIG. 2, the laminated steel stack 22 includes a plurality of individual steel sheets 28 that are stacked together along a central longitudinal axis A of the laminated steel stack 22 that coincides with the central longitudinal axis A of the rotor assembly 20 shown in FIG. 1. In this disclosure, a radial related direction, an axial related direction, or a circumferential related direction are with respect to the axis of rotation A of the rotor assembly 20 unless stated otherwise.

Each steel sheet 28 includes openings along its radially outer diameter that form the slots 26 when a stack of the steel sheets 28 are aligned to form the laminated steel stack 22. As shown in FIG. 1, the slots 26 in the laminated steel stack 22 are configured to accept the cast conductive bars 30 as part of the rotor assembly 20. Before the conductive bars 30 are cast into the slots 26 in the laminated steel stack 22, a thin-film composite 32 (FIG. 3) is applied to a slot surface 27 of the laminated steel stack 22 that defines the slots 26. The thin-film composite 32, such as a thin-foil composite having a thickness no greater than 25 microns, can include a copper and carbon nanotube composite, a copper-graphene composite, or another similar type of highly conductive composite material with the electric conductivity higher than 105% IACS. One feature of the thin-film composite 32 is improved adhesion with the cast conductive bars 30 that leads to improved conductivity of the cast conductive bars 30. Also, the thin-film composites 32 can improve power density and performance of electric machines during high-frequencies or low speed and eliminate the welding and inner laminar shorting from occurring during the casting process.

FIG. 3 illustrates an example method 100 of applying the thin-film composite 32 to a slot surface 27 of the laminated steel stack 22. As shown in FIG. 3, the thin-film composite 32 is stored in a roll 34 that can be unwound on rollers 36 and wound onto a transfer member 40, such as a transfer roller. In the illustrated example, the thin-film composite is wound onto the transfer member 40 as the transfer member 40 is wound in direction R1.

Once predetermined length of the thin-film composite 32 has been wound onto the transfer member 40, a laser 42 can cut the thin-film composite 32 precisely to the predetermined length for applying to one of the slots 26. In the illustrated example, the end of the thin-film composite 32 cut from the remainder of the thin-film composite on the roll 34 is placed on the laminated steel stack 22 on a first circumferential side of the slot 26. When placing the thin-film composite 32 on the laminated steel stack 22, an adhesive conductive material can be applied to one or both of the laminated steel stack 22 or one side of the thin-film composite 32. Additionally, the conductive adhesive material can be heat activated, such as by heating the laminated steel stack 22 or sending warm air through gaps or openings in the laminated steel stack 22, to activate the adhesive material. Furthermore, the adhesive can include a ceramic based adhesive material that prevents off-gassing during the casting process discussed below.

Once the adhesive material 38 has been applied as discussed above, the transfer member 40 is rotated in a second rotation direction R2 relative to an axis of rotation of the transfer member 40 to unwind the thin-film composite 32 onto a portion of a circumferential surface of the laminated steel stack 22. The transfer member 40 continues to unwind and apply pressure to the thin-film composite 32 to improve adhesion between the thin-film composite 32 and the laminated steel stack 22.

The transfer member 40 continues along a radially outer surface of the laminated steel stack 22 and into the slot 26 along the slot surface 27. In one example, a second end of the thin-film composite 32 that was initially placed on the transfer member 40 is located on a second opposite side of the slot 26 from the first end of the thin-film composite 32. The method 100 shown in FIG. 3 can then repeat for each additional slot 26 on the laminated steel stack 22 until the remaining slots 26 are coated with the thin-film composite 32.

FIG. 4 illustrates another example method 200 for applying the thin-film composite 32 to the laminated steel stack 22. As shown in FIG. 4, the thin-film composite 32 is stored on the roll 34 and travels through rollers 36 until the thin-film composite 32 reaches a guiding roller 44. With the method 200 of FIG. 4, a free end of the thin-film composite 32 is secured relative to the radially outer surface of the laminated steel stack 22 with a stopper 46.

In one example, the stopper 46 includes an extendable arm 48 that extends in a generally radial direction as the laminated steel stack 22 rotates to a corresponding location relative to the slot 26. The stopper 46 can then secure the thin-film composite 32 between the extendable arm 48 and the laminated steel stack 22. A transfer member 50, such as a transfer roller, then applies a compressive force to the thin-film composite 32 to attach it to the laminated steel stack 22.

In the illustrated example, the transfer member 50 follows a profile of the laminated steel stack 22 from a first circumferential side of one of the slots 26, along the slot surface 27, and to a second circumferential side of the slot 26. An adhesive material 38 can be used with the method 200 of FIG. 4 in a similar manner as discussed above with respect to the method 100 in FIG. 3 for securing the thin-film composite 32 relative to the laminated steel stack 22.

One feature of the transfer member 50 when compared to the transfer member 40, is that the transfer member 50 can include a larger diameter that more closely approximates a width of the slot 26 in the circumferential face of the laminated steel stack 22. The transfer member 50 can have a larger diameter because it does not have the added thickness from transferring the entire length of the thin-film composite 32 for the slot 26. Also, the larger diameter on the transfer member 50 allows for a greater surface area of contact between the transfer member 50 and the thin-film composite 32. This greater surface area of contact can increase the speed of applying the thin-film composite 32 with the transfer member 50 in the method 200 when compared to the transfer member 40 and the method 100.

Once a predetermined length of the thin-film composite 32 has been applied to the laminated steel stack 22 with the method 200, a laser 52 cuts the thin-film composite 32. The stopper 46 can be removed after the thin-film composite 32 has been cut by the laser 52 or once a predetermined length of the thin-film composite 32 has been applied to ensure that the thin-film composite 32 does not shift relative to the laminated steel stack 22 while being applied with the transfer member 50. The method 200 shown in FIG. 4 can then repeat for each additional slot 26 on the laminated steel stack 22 until the remaining slots 26 are coated with the thin-film composite 32.

The thin-film composite 32 can also extend outward from axial ends of the laminated steel stack 22. In one example, as shown in FIG. 4, the ends of the thin-film composite are folded over the axial ends of the laminated steel stack 22. Alternatively, the thin-film composite can simply extend past one or more of the axial ends of the laminated steel stack 22 such that they will be surrounded by the casting material as discussed below. Furthermore, adjacent sections of the thin-film composite can be welded to each other. These configurations for the thin-film composite 32 can apply the other methods disclosed herein.

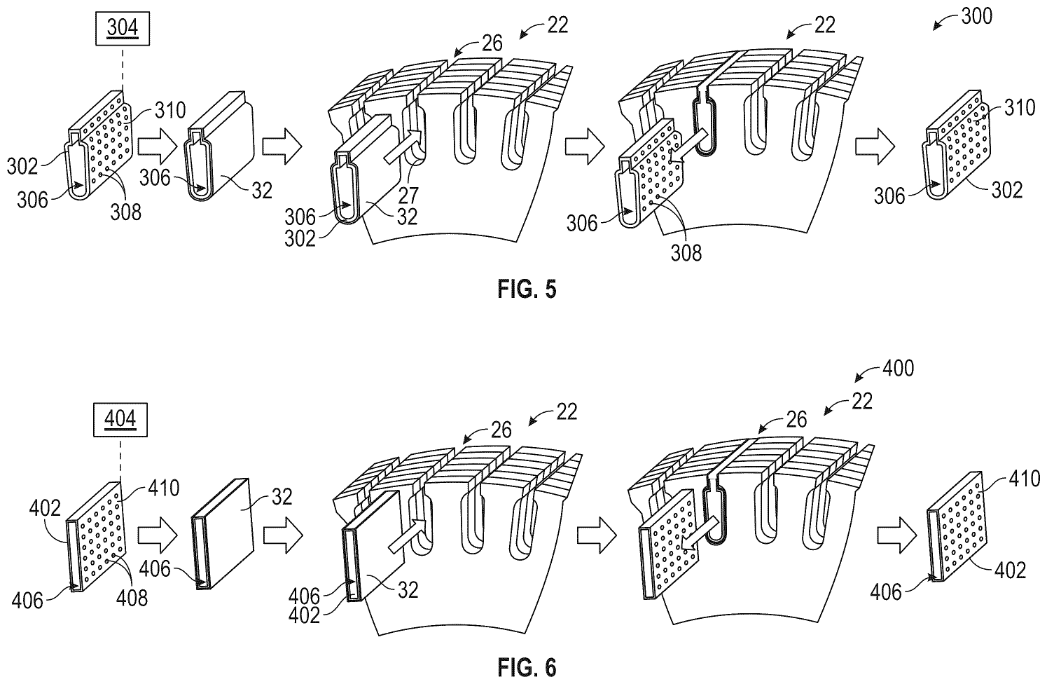

FIG. 5 illustrates another example method 300 of applying the thin-film composite 32 to the laminated steel stack 22. In the illustrated, a predetermined length of the thin-film composite 32 is placed on a transfer member 302, such as a slot insert. The thin-film composite 32 is secured relative to the transfer member 302 by an air source 304 applying a vacuum to an internal cavity 306 in the transfer member 302. The air source 304 remains in fluid communication with the internal cavity 306 throughout the method 300.

The transfer member 302 includes passageways 308 that extend through a body portion of the transfer member 302 from the internal cavity 306 to an outer surface 310 of the transfer member 302. When the air source 304 applies the vacuum to the internal cavity 306 of the transfer member 302, the thin-film composite 32 becomes fixed to the outer surface 310 of the transfer member 302 as the vacuum is drawn through the passageways 308.

Alternatively, the transfer member 302 can use magnetism to secure the thin-film composite 32 instead of using the vacuum from the air source 304. A magnetic foil, such as a ferrous based foil, can be overlapped with the thin-film composite 32 if the thin-film composite 32 is not magnetic. The ferrous foil can be removed prior to casting to prevent the ferrous material from interfering with the casting material adhering to the thin-film composite 32.

In the illustrated example, the transfer member 302 includes a profile or contour of the outer surface 310 that follows a shape or contour of the slot 26. In particular, the transfer member 302 includes a narrow portion that corresponds to a neck region of the slot 26 adjacent the circumferential surface of the laminated steel stack 22 that expands to a wider portion that follows profile or contour of radially inner portion of the slot 26.

Once the transfer member 302 and the thin-film composite 32 have been placed within the slot 26, the air source 304 applies a positive pressure to the internal cavity 306 of the transfer member 302 to cause the thin-film composite 32 to separate from the transfer member 302 and adhere onto the slot surface 27 of one of the slots 26. When the transfer member 302 utilizes magnetism to secure the thin-film composite 32, the air source 304 will selectively apply positive pressure to separate the thin-film composite 32 without applying a vacuum during the method 300.

An adhesive conductive material can be applied to one of the slot surface 27 or an outer surface of the thin-film composite 32 opposite from the transfer member 302 to aid in securing the thin-film composite 32 relative to the slot 26. With the thin-film composite 32 attached to the slot surface 27, the transfer member 302 is removed from the slot 26 in preparation for receiving another predetermined length of the thin-film composite 32 to repeat the method 300 for the next slot 26 on the laminated steel stack 22 that requires the thin-film composite 32. In particular, the laminated steel stack 22 can be rotated to align the next slot 26 with the transfer member 302 as needed.

FIG. 6 illustrates another example method 400 of applying the thin-film composite 32 in one of the slots 26 in the laminated steel stack 22. In the illustrated example, a predetermined length of the thin-film composite 32 is placed on a transfer member 402, such as a slot insert. The thin-film composite 32 is secured relative to the transfer member 402 by an air source 404 applying a vacuum to an internal cavity 406 in the transfer member 402.

The transfer member 402 includes passageways 408 that extend through a body portion of the transfer member 402 from the internal cavity 406 to an outer surface 410 of the transfer member 402. When the air source 404 applies the vacuum pressure to the internal cavity 406 of the transfer member 402, the thin-film composite 32 becomes fixed to the outer surface 410 of the transfer member 402 as the vacuum is drawn through the passageways 408.

Alternatively, the transfer member 402 can be magnetized instead of using the vacuum from the air source 404 as discussed above with respect to the method 300 and the transfer member 302.

In the illustrated example, the transfer member 402 includes a profile or contour of the outer surface 410 that is rectangular. In particular, the transfer member 402 includes a width that is less than a width of the neck portion of the slot 26 and a height greater than or equal to a radial dimension of the slot 26 to ensure a sufficient length of thin-film composite is available to coat the slot 26. One feature of the transfer member 402, is that it can be utilized in connection with slots of varying geometry if the width of the neck portion of the slot is sufficient to accommodate the transfer member 402. While the illustrated example shows the transfer member 402 entering the slot 26 from an axial direction, the transfer member 402 can be inserted into the slot 26 in a radial direction through the slot opening in the circumferential surface of the laminated steel stack 22. This can allow the method 400 to be accomplished with less axial space and it can reduce a travel distance of transfer member 402 and the thin-film composite 32 to a radial dimension of the slot 26 and not an entire axial length of the slot 26 depending on the configuration of the laminated steel stack 22.

Once the transfer member 402 and the thin-film composite 32 have been placed within the slot 26, the air source 404 applies a positive pressure to the internal cavity 406 of the transfer member 402 to fix the thin-film composite 32 onto the slot surface 27 of a corresponding one of the slots 26. For the example of the transfer member 402 being magnetic, the air source 404 will selectively apply the positive pressure and not provide a vacuum.

An adhesive material can be applied to one of the slot surface 27 or a surface of the thin-film composite 32 opposite from the transfer member 402 to aid in securing the thin-film composite 32 relative to the slot 26. The transfer member 402 can then be removed from the slot 26 in preparation for receiving another predetermined length of the thin-film composite 32 for placing within another one of the slots 26 in the laminated steel stack 22. In particular, the laminated steel stack 22 can be rotated to align the next slot 26 with the transfer member 402 as needed.

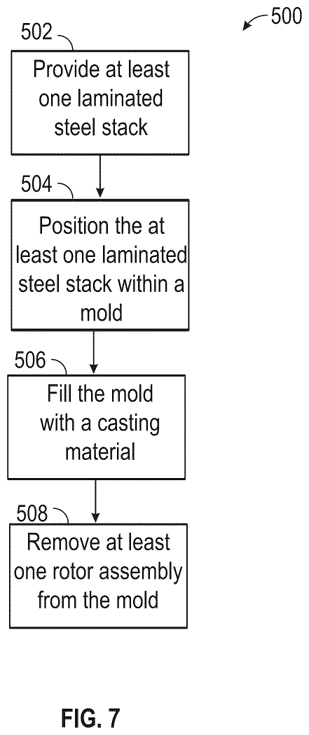

FIG. 7 illustrates a method 500 of casting the rotor assembly 20. The method 500 begins with providing at least one laminated steel stack 22 with the thin-film composite 32 in the slots 26 at Block 502. The thin-film composite 32 can be applied to the slots 26 in the laminated steel stack 22 using the methods 100, 200, 300, or 400 discussed above.

The laminated steel stack 22 with the thin-film composite 32 can then be placed in a mold at Block 504. In one example, the mold used at Block 504 is configured to accept a single laminated steel stack 22 with the thin-film composite 32 in the slots 26. However, in another example, the mold can accept multiple laminated steel stacks 22 with the thin-film composite 32 in the slots 26 to allow for more than one rotor assembly 20 to be formed from a single casting process. Once the at least one laminated steel stack 22 from Block 504 has been positioned in the mold, the method proceeds to Block 506.

At Block 506, the mold is filled with a molten casting material, such as aluminum. The casting material fills the mold to form the cast conductive bars 30 in the slots 26 and the end rings 24 shown in FIG. 1. In one example, a surface of the thin-film composite 32 that contacts the molten casting material includes a surface roughness to aid in removing surface oxide from the molten casting material to improve filling of the mold. Depending on the desired surface roughness, an additional roughness coating, such as a flux of copper or aluminum powders, can be applied to the thin-film composite. After the mold has been filled with the casting material and the casting material has been allowed to solidify for a predetermined length of time, the method 500 proceeds to Block 508.

At Block 508, at least one cast rotor assembly 20 is removed from the mold. The cast rotor assembly 20 can undergo a post casting processes. For example, additional trimming or machine may be performed on the cast rotor assembly 20 in order to prepare it for use in an electric machine, such as in an induction motor in an electrified vehicle.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element, or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A method of making a rotor assembly, the method comprising;
positioning a thin-film composite with a transfer member into engagement with a slot surface of a corresponding one of a plurality of slots formed around a perimeter of a laminated steel stack, wherein each of the plurality of slots in the laminated steel stack are defined by a slot surface; and
placing the laminated steel stack in a casting mold, wherein the casting mold includes cavities for defining a pair of end rings on opposite ends of the laminated steel stack that are in fluid communication with the plurality of slots.

2. The method of claim 1, wherein the thin-film composite includes an ultra-conducting composite having carbon nanotubes with a thickness of less than or equal to 25 microns.

3. The method of claim 1, wherein a portion of the thin-film composite engages a first axial end of the laminated steel stack and a second axial end of the laminated steel stack.

4. The method of claim 1, wherein a portion of the thin-film composite engages a radially outer surface defining an outer circumference of the laminated steel stack.

5. The method of claim 1, wherein the thin-film composite includes a predetermined length having a first end located on a first circumferential side of one of the plurality of slots and a second end of the thin-film composite on a second circumferential side of the corresponding one of the plurality of slots.

6. The method of claim 1, wherein positioning the thin-film composite with the transfer member includes:
rolling a predetermined length of the thin-film composite around on the transfer member, wherein the transfer member includes a transfer roller; and
positioning the predetermined length of the thin-film composite in contact with the slot surface of a corresponding one of the plurality of slots while unrolling the thin-film composite from the transfer member.

7. The method of claim 6, wherein rolling the predetermined length of the thin-film composite around the transfer member includes cutting the thin-film composite with a laser at the predetermined length.

8. The method of claim 1, wherein positioning the thin-film composite with the transfer member includes:
fixing a first end of the thin-film composite relative to the laminated steel stack;
positioning the thin-film composite in contact with the slot surface of a corresponding one of the plurality of slots while unrolling the thin-film composite from the transfer member; and
cutting the thin-film composite to a predetermined length.

9. The method of claim 1, wherein positioning the thin-film composite includes:
securing the thin-film composite to an outer surface of the transfer member, wherein the transfer member includes a slot insert;
placing the transfer member with the thin-film composite within one of the plurality of slots in the laminated steel stack;
transferring the thin-film composite from the transfer member to the slot surface or a corresponding one of the plurality of slots; and
removing the transfer member from the laminated steel stack.

10. The method of claim 9, wherein the transfer member includes a body portion that defines an internal cavity on an inner side and the outer surface on an outer side with a plurality of passages defined by the body portion and fluidly connecting the internal cavity with the outer surface.

11. The method of claim 10, wherein securing the thin-film composite to the outer surface of the transfer member includes applying a vacuum to the internal cavity of the transfer member.

12. The method of claim 10, wherein transferring the thin-film composite to the slot surface includes applying a positive pressure source to the internal cavity of the transfer member.

13. The method of claim 10, wherein the transfer member is magnetic.

14. A method of assembling a laminated steel stack for a rotor assembly, the method comprising:
locating a thin-film composite in contact with a transfer member; and
positioning the thin-film composite with the transfer member into engagement with a slot surface of a corresponding one of a plurality of slots formed around a perimeter of the laminated steel stack, wherein each of the plurality of slots in the laminated steel stack are defined by a slot surface.

15. The method of claim 14, wherein positioning the thin-film composite with the transfer member includes:
rolling a predetermined length of the thin-film composite around on the transfer member, wherein the transfer member includes a transfer roller; and
positioning the predetermined length of the thin-film composite in contact with the slot surface of a corresponding one of the plurality of slots while unrolling the thin-film composite from the transfer member.

16. The method of claim 14, wherein positioning the thin-film composite with the transfer member includes:
fixing a first end of the thin-film composite relative to the laminated steel stack;
positioning the thin-film composite in contact with the slot surface of a corresponding one of the plurality of slots while unrolling the thin-film composite from the transfer member; and
cutting the thin-film composite to a predetermined length.

17. The method of claim 14, wherein positioning the thin-film composite includes:
securing the thin-film composite to an outer surface of the transfer member, wherein the transfer member includes a slot insert;
placing the transfer member with the thin-film composite within one of the plurality of slots in the laminated steel stack;
transferring the thin-film composite from the transfer member to the slot surface or a corresponding one of the plurality of slots; and
removing the transfer member from the laminated steel stack.

18. The method of claim 17, wherein the transfer member includes a body portion that defines an internal cavity on an inner side and the outer surface on an outer side with a plurality of passages defined by the body portion and fluidly connecting the internal cavity with the outer surface.

19. A rotor assembly comprising:
a laminated steel stack having a plurality of steel sheets, wherein an outer surface of the laminated steel stack includes a plurality of slots extending continuously from a first axial end of the laminated steel stack to a second axial end of the laminated steel stack;
a thin-film composite in engagement with a slot surface of each of the plurality of slots in the laminated steel stack; and
a rotor cage including:
a plurality of cast conductor bars located in corresponding one of the plurality of slots in the laminated steel stack and in contact with the thin-film composite; and
a first end ring located at a first axial end of the rotor cage and a second end ring located at a second axial end of the rotor cage, wherein the first end ring, the second end ring, and the plurality of cast conductive bars are comprised of cast aluminum.

20. The rotor assembly of claim 19, wherein the thin-film composite includes an ultra-conducting composite having carbon nanotubes with a thickness of less than or equal to 25 microns and the thin-film composite extends axially outward from at least one of the first axial end of the laminated steel stack or the second axial end of the laminated steel stack.
